(19) United States
(12) Patent Application Publication
(10) Pub. No.: US 2023/0259049 A1
(43) Pub. Date: Aug. 17, 2023

(54) METHOD FOR PRODUCING TONER FOR DEVELOPING ELECTROSTATIC CHARGE IMAGE AND TONER FOR DEVELOPING ELECTROSTATIC CHARGE IMAGE

(71) Applicant: FUJIFILM Business Innovation Corp., Tokyo (JP)

(72) Inventor: Kazutsuna SASAKI, Kanagawa (JP)

(73) Assignee: FUJIFILM Business Innovation Corp., Tokyo (JP)

(21) Appl. No.: 17/950,472

(22) Filed: Sep. 22, 2022

(30) Foreign Application Priority Data
Feb. 14, 2022 (JP) 2022-020785

(51) Int. Cl. G03G 9/08; G03G 9/093; G03G 9/087

(52) U.S. Cl. CPC G03G 9/0804; G03G 9/0819; G03G 9/09371; G03G 9/09328; G03G 9/08755

(57) ABSTRACT

A method for producing a toner for developing an electrostatic charge image includes: performing first aggregation involving aggregating at least resin particles and releasing agent particles to prepare a dispersion A that contains first aggregated particles that will form a core; performing second aggregation involving adding, to the dispersion A, a dispersion B that contains shell resin particles that will form a shell so as to cause the shell resin particles to adhere to the first aggregated particles and form second aggregated particles; and performing fusion involving heating and fusing the second aggregated particles to form toner particles, in which a solid component concentration (A) of the dispersion A and a solid component concentration (B) of the dispersion B satisfy a relationship, (A)<(B).

### CROSS-REFERENCE TO RELATED APPLICATIONS

This application is based on and claims priority under 35 USC 119 from Japanese Patent Application No. 2022-020785 filed Feb. 14, 2022.

### BACKGROUND

### (i) Technical Field

The present disclosure relates to a method for producing a toner for developing an electrostatic charge image, and a toner for developing an electrostatic charge image.

### (ii) Related Art

Methods, such as electrophotography, for visualizing image information are now being used in a variety of fields. In electrophotography, an electrostatic charge image is formed as image information on a surface of an image bearing member through charging and formation of an electrostatic charge image. Then a toner image is formed on the surface of the image bearing member by using a developer that contains a toner, then transferred onto a recording medium, and then fixed to the recording medium. Image information is visualized into an image through these steps.

For example, Japanese Unexamined Patent Application Publication No. 2014-048525 discloses a toner for developing an electrostatic latent image, the toner including a toner core particle that contains at least a binder resin, a coloring agent, and a releasing agent, and a shell layer that covers the entire surface of the toner core particle, in which the shell layer is formed by using spherical resin fine particles. When a surface of the toner for developing an electrostatic latent image is observed with a scanning electron microscope, a structure derived from the spherical resin fine particles is not observed in the shell layer of a toner particle having a particle diameter of 6 μm or more and 8 μm or less, and when a cross section of the toner for developing an electrostatic latent image is observed with a transmission electron microscope, a clear interface is observed between the toner core particle and the shell layer, and cracks running in a direction substantially perpendicular to the surface of the toner core particle are not observed from the inside of the shell layer.

### SUMMARY

In a toner that has a core containing a binder resin and a releasing agent, and a shell that covers the core, typically, coating nonuniformity easily occurs in the shell, and the ratio in which the releasing agent becomes exposed in the toner surfaces (hereinafter, this ratio is also simply referred to as the “releasing agent surface exposure ratio”) has increased in some cases.

Aspects of non-limiting embodiments of the present disclosure relate to a method for producing a toner for developing an electrostatic charge image, the method including a first aggregation step of aggregating at least resin particles and releasing agent particles to prepare a dispersion A that contains first aggregated particles, a second aggregation step of adding, to the dispersion A, a dispersion B that contains shell resin particles so as to cause the shell resin particles to adhere to the first aggregated particles and form second aggregated particles, and a fusing step of heating and fusing the second aggregated particles to form toner particles. The toner produced by this method has a small releasing agent surface exposure ratio compared to when the relationship between a solid component concentration (A) of the dispersion A and a solid component concentration (B) of the dispersion B is (A)>(B) or (A)=(B).

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a method for producing a toner for developing an electrostatic charge image, the method including: performing first aggregation involving aggregating at least resin particles and releasing agent particles to prepare a dispersion A that contains first aggregated particles that will form a core; performing second aggregation involving adding, to the dispersion A, a dispersion B that contains shell resin particles that will form a shell so as to cause the shell resin particles to adhere to the first aggregated particles and form second aggregated particles; and performing fusion involving heating and fusing the second aggregated particles to form toner particles, in which a solid component concentration (A) of the dispersion A and a solid component concentration (B) of the dispersion B satisfy a relationship, (A)<(B).

### BRIEF DESCRIPTION OF THE DRAWINGS

Exemplary embodiments of the present disclosure will be described in detail based on the following figures, wherein:

FIG. 1 is a schematic diagram illustrating one example of an image forming apparatus according to an exemplary embodiment; and

FIG. 2 is a schematic diagram illustrating one example of a process cartridge according to an exemplary embodiment.

### DETAILED DESCRIPTION

Exemplary embodiments of the present disclosure will now be described in detail.

In numerical ranges described stepwise, the upper limit or the lower limit of one numerical range may be substituted with an upper limit or a lower limit of a different numerical range also described stepwise.

Furthermore, in any numerical range, the upper limit or the lower limit of the numerical range may be substituted with a value indicated in Examples.

When a composition contains a component and more than one substances that correspond to that component are present in the composition, the amount of that component is a total amount of more than one substances present in the composition unless otherwise noted.

The term “step” refers not only to an independent step but also to any feature that fulfills the intended purpose although such a feature may not be clearly distinguishable from other steps.

Method for producing toner for developing electrostatic charge image

A method for producing a toner for developing an electrostatic charge image according to an exemplary embodiment includes a first aggregation step of aggregating at least resin particles and releasing agent particles to prepare a dispersion A that contains first aggregated particles that will form a core; a second aggregation step of adding, to the dispersion A, a dispersion B that contains shell resin particles that will form a shell so as to cause the shell resin particles to adhere to the first aggregated particles and form second aggregated particles; and a fusing step of heating and fusing the second aggregated particles to form toner particles, in which a solid component concentration (A) of the dispersion A and a solid component concentration (B) of the dispersion B satisfy a relationship, (A)<(B).

A toner for developing an electrostatic charge image according to an exemplary embodiment is obtained by the method for producing a toner for developing an electrostatic charge image of this exemplary embodiment. In the description below, the toner for developing an electrostatic charge image may be simply referred to as a toner.

In order to improve releasability during fixing, typically, a releasing agent is added to the toner particles. Since releasability is affected by the amount of the releasing agent exuding from the toner particles, ideally, the releasing agent may be present on the surface side of the toner particles. However, in a typical toner, the releasing agent exposure ratio tends to be high in the surfaces of the toner particles. This is presumably attributable to the nonuniformity in the aggregation action of the shell resin particles (more specifically, the balance between the aggregating power and repulsive force) and the resulting degradation of the coverage provided by the shell resin particles.

When more releasing agent is exposed in the toner particle surfaces, the stress inside the developing unit increases by, for example, repeated continuous low-area-coverage outputs, and thus sinking of the external agent easily occurs as the releasing agent becomes exposed. On the surface side of the toner particles where the external additive is absent, sufficient frictional charges cannot be given, and the stability of the image density tends to be low.

Meanwhile, in the method for producing a toner for developing electrostatic charge image according to this exemplary embodiment, in the second aggregation step, the solid component concentration (A) of the dispersion (A) and the solid component concentration (B) of the dispersion B satisfy (A)<(B), and the solid component concentration of the dispersion B is higher than the solid component concentration of the dispersion A. As a result, even when a region where the concentration gradient of the first aggregated particles that will form a core and shell resin particles that will form a shell is large is generated locally in the solution, abnormal aggregation that occurs between the shell resin particles is reduced due to the feature that the solid component concentration of the dispersion B containing the shell resin particles is higher than the concentration of the first aggregated particles. As a result, the coverage provided by the shell resin particles is improved, and the releasing agent surface exposure ratio decreases in the toner particles. Thus, excellent chargeability can be obtained while reducing sinking of the external additive caused by the releasing agent exposure on the surfaces of the toner particles. Thus, stable image density can be obtained even under stringent load conditions during development.

### First Aggregation Step

The method for producing a toner for developing an electrostatic charge image according to this exemplary embodiment includes a first aggregation step.

In the first aggregation step, at least resin particles and releasing agent particles are aggregated to prepare a dispersion A that contains first aggregated particles that serve as a core.

The dispersion A contains at least resin particles and releasing agent particles.

If needed, the dispersion A may further contain an aggregating agent, a surfactant, a dispersion stabilizer, and coloring agent particles, for example. Details of the components contained in the toner particles, such as a binder resin constituting the resin particles, the releasing agent, the coloring agent, etc., are stated in the later section.

An example of the dispersion medium used in the dispersion A is an aqueous medium. Examples of the aqueous medium include water such as distilled water and ion exchange water, alcohols, and mixtures thereof. The dispersion media can be used alone or in combination.

Among the dispersion media described above, the dispersion medium used in the dispersion A is preferably an aqueous medium having a water content of 90 mass % or more, more preferably 95 mass % or more, and most preferably 100 mass %, in other words, water, relative to all of the solvents.

The volume average particle diameter of the resin particles is preferably 0.01 μm or more and 1 μm or less, more preferably 0.08 μm or more and 0.8 μm or less, and yet more preferably 0.1 μm or more and 0.6 μm or less.

The volume average particle diameter of the resin particles is determined by using a particle size distribution obtained by measurement with a laser diffraction particle size distribution meter (for example, LA-700 produced by Horiba Ltd.), drawing a cumulative distribution with respect to volume from the small-diameter-side relative to the divided particle size ranges (channels), and assuming the particle diameter at 50% accumulation relative to all particles as the volume average particle diameter D50v.

The volume average particle diameter of the releasing agent particles is preferably 0.01 μm or more and 1 μm or less, more preferably 0.08 μm or more and 0.8 μm or less, and yet more preferably 0.1 μm or more and 0.6 μm or less. The volume average particle diameter of the releasing agent particles is measured by the same procedure as the volume average particle diameter of the resin particles.

The first aggregation step may involve mixing a resin particle dispersion and a releasing agent particle dispersion to obtain a mixed dispersion, adjusting the pH of the mixed dispersion to acidic (for example, a pH of 2 or more and 5 or less) in the presence of an aggregating agent, and aggregating at least the resin particles and the releasing agent particles contained in the mixed dispersion to prepare a dispersion A that contains first aggregated particles. Adjusting the pH of the mixed dispersion to acidic appropriately adjusts the surface charges on the resin particles and the releasing agent particles, and thus first aggregated particles can be easily and efficiently formed.

The first aggregation step may involve mixing a resin particle dispersion and a releasing agent particle dispersion to obtain a mixed dispersion, heating the mixed dispersion at a temperature corresponding to the glass transition temperature of the resin particles (for example, a temperature 30° C. to 10° C. lower than the glass transition temperature of the resin particles), and aggregating at least the resin particles and the releasing agent particles contained in the mixed dispersion to prepare a dispersion A that contains first aggregated particles. Performing heating at a temperature lower than the glass transition temperature of the resin particles appropriately places the releasing agent in the toner particles, and thus excess exuding of the releasing agent onto toner particle surfaces, degradation of thermal storage properties, and degradation of the image density stability are reduced.

The first aggregation step may involve mixing a resin particle dispersion and a releasing agent particle dispersion to obtain a mixed dispersion, adjusting the pH of the mixed dispersion to acidic (for example, a pH of 2 or more and 5 or less), and heating the mixed dispersion at a temperature corresponding to the glass transition temperature of the resin particles (for example, a temperature 30° C. to 10° C. lower than the glass transition temperature of the resin particles) in the presence of an aggregating agent, and aggregating at least the resin particles and the releasing agent particles contained in the mixed dispersion to prepare a dispersion A that contains first aggregated particles. The aforementioned steps allow the first aggregated particles to grow more smoothly. Furthermore, abnormal aggregation of the shell resin particles in the second aggregation step described below is more efficiently inhibited, the releasing agent is appropriately placed in the toner particles, and thus excess exuding of the releasing agent onto toner particle surfaces, degradation of thermal storage properties, and degradation of the image density stability are reduced.

The first aggregation step may be a step of aggregating resin particles and releasing agent particles in the presence of an aggregating agent so as to prepare a dispersion A that contains first aggregated particles.

Examples of the aggregating agent include inorganic metal salts, divalent or higher metal complexes, and surfactants. The aggregating agents may be used alone or in combination.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide. The inorganic metal salt may contain an aluminum compound.

Examples of the divalent or higher metal complexes include metal salts of aminocarboxylic acids and metal salts of phosphonic acid. Examples of the metal salts of aminocarboxylic acids include calcium salts, magnesium salts, iron salts, and aluminum salts of known chelates such as ethylenediaminetetraacetic acid, propanediaminetetraacetic acid, nitrilotriacetic acid, triethylenetetraminehexaacetic acid, and diethylenetriaminepentaacetic acid. Examples of the metal salts of phosphonic acid include calcium salts, magnesium salts, iron salts, and aluminum salts of HEDP (hydroxyethylidenediphosphonic acid), NTMP (nitrilotris(methylenephosphonic acid)), PBTC (phosphonobutane-1,2,4-tricarboxylic acid), and EDTMP (N,N,N′,N′-ethylenediaminetetrakis(methylenephosphonic acid)).

When an inorganic metal salt and a divalent or higher metal complex are used as the aggregating agent, an additive that forms a complex or a similar bond with the metal ions in the aggregating agent may be further added. Examples of the additive are chelating agents.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added relative to, for example, 100 parts by mass of the resin particles is preferably 0.01 parts by mass or more and 5.0 parts by mass or less and more preferably 0.1 parts by mass or more and less than 3.0 parts by mass.

Examples of the surfactant include anionic surfactants such as sulfate esters, sulfonates, phosphate esters, and soaps; cationic surfactants such as amine salts and quaternary ammonium salts; and nonionic surfactants such as polyethylene glycol, alkyl phenol-ethylene oxide adducts, and polyhydric alcohols. Among these, anionic surfactants and cationic surfactants are particularly preferable. The nonionic surfactants may be used in combination with anionic surfactants or cationic surfactants. When the dispersion A further contains a dispersion stabilizer, the surfactant may have a polarity opposite to the polarity of the dispersion stabilizer.

The aggregating agent preferably contains at least one of an inorganic metal salt and a divalent or higher metal complex among those described above, and more preferably contains an inorganic metal salt. When a metal complex having a valency of 2 or more is used as the aggregating agent, the amount of the surfactant used is reduced, and the charge properties are likely to be improved.

When the aggregating agent is to be used, the aggregating agent is preferably added to the mixed dispersion in the step that precedes the pH adjusting step, and more preferably added to the mixed dispersion in a step between the mixing step and the pH adjusting step. The aggregating agent may be added to the mixed dispersion containing the resin particle dispersion and the releasing agent particle dispersion in a room temperature (for example, 25° C.) environment while being stirred with a rotational shear-type homogenizer.

The volume average particle diameter of the first aggregated particles is preferably 3000 nm or more and 7200 nm or less, more preferably 3000 nm or more and 6800 nm or less, and yet more preferably 3200 nm or more and 6400 nm or less. The volume average particle diameter of the first aggregated particles can be measured by the same procedure as the volume average particle diameter of the resin particles.

When the volume average particle diameter of the first aggregated particles is 3000 nm or more, local generation of a region where the first resin particle concentration is low is further suppressed in the second aggregation step, and thus the abnormal aggregation that involves aggregation between shell resin particles is further reduced. As a result, the coverage provided by the shell resin particles is improved, and the releasing agent surface exposure ratio further decreases in the toner particles.

When the volume average particle diameter of the first aggregated particles is 7200 nm or less, the shell resin particles more efficiently adhere to the first aggregated particles and the second aggregated particles are smoothly formed. As a result, the coverage provided by the shell resin particles is improved, and the releasing agent surface exposure ratio further decreases in the toner particles.

### Second Aggregation Step

The method for producing a toner according to this exemplary embodiment includes a second aggregation step.

In the second aggregation step, a dispersion B containing shell resin particles that will form a shell is added to the dispersion A, and the shell resin particles are allowed to adhere to the first aggregated particles to form second aggregated particles.

The dispersion B contains shell resin particles.

If needed, the dispersion B may further contain releasing agent particles, an aggregating agent, a surfactant, a dispersion stabilizer, and coloring agent particles, for example. The dispersion B may contain no aggregating agent from the viewpoint of further reducing abnormal aggregation of the shell resin particles and increasing the aggregation uniformity.

The details of the components in the dispersion B such as the releasing agent particles, the aggregating agent, the surfactant, the dispersion stabilizer, and the coloring agent particles are the same as those of the components in the dispersion A.

The details of the dispersion medium in the dispersion B are the same as those of the dispersion medium in the dispersion A.

The solid component concentration (A) of the dispersion A and the solid component concentration (B) of the dispersion B satisfy the relationship (A)<(B). As a result, even when a region where the first resin particle concentration is low locally occurs in the solution, abnormal aggregation that involves aggregation between the shell resin particles is reduced. As a result, the coverage provided by the shell resin particles is improved, and the releasing agent surface exposure ratio decreases in the toner particles.

The difference ((B)−(A)) between the solid component concentration (B) of the dispersion B and the solid component concentration (A) of the dispersion A is preferably 5 mass % or more and 30 mass % or less, more preferably 6 mass % or more and 20 mass % or less, and yet more preferably 8 mass % or more and 15 mass % or less.

When the difference ((B)−(A)) is 5 mass % or more, local generation of a region where the first resin particle concentration is low is further suppressed in the second aggregation step, and thus the abnormal aggregation that involves aggregation between shell resin particles is further reduced. As a result, the coverage provided by the shell resin particles is improved, and the releasing agent surface exposure ratio further decreases in the toner particles.

When the difference ((B)−(A)) is 30 mass % or less, abnormal aggregation of shell resin particles caused by a large difference in concentration between the first aggregated particles and the shell resin particles in the second aggregation step is further reduced; thus, the releasing agent surface exposure ratio of the toner particles is further decreased.

The solid component concentration (A) of the dispersion A is preferably 5 mass % or more and 20 mass % or less, more preferably 10 mass % or more and 18 mass % or less, and yet more preferably 12 mass % or more and 18 mass % or less.

When the difference the solid component concentration (A) of the dispersion A is 5 mass % or more, local generation of a region where the first resin particle concentration is low is further suppressed in the second aggregation step, and thus the abnormal aggregation that involves aggregation between shell resin particles is further reduced. As a result, the coverage provided by the shell resin particles is improved, and the releasing agent surface exposure ratio further decreases in the toner particles.

When the solid component concentration (A) of the dispersion A is 20 mass % or less, the local increase in viscosity associated with re-aggregation for forming second aggregated particles in the solution containing the dispersion A and the dispersion B mixed with each other is further suppressed, and thus mixing failure and abnormal aggregation between shell resin particles failing to adhere to the first aggregated particles are further reduced.

The solid component concentration (B) of the dispersion B is preferably 15 mass % or more and 40 mass % or less, more preferably 18 mass % or more and 18 mass % or less, and yet more preferably 20 mass % or more and 30 mass % or less.

When the solid component concentration (B) of the dispersion B is 15 mass % or more, local generation of a region where the first resin particle concentration is low is further suppressed in the second aggregation step, and thus the abnormal aggregation that involves aggregation between shell resin particles is further reduced. As a result, the coverage provided by the shell resin particles is improved, and the releasing agent surface exposure ratio further decreases in the toner particles.

When the solid component concentration (B) of the dispersion B is 40 mass % or less, the local increase in viscosity associated with re-aggregation for forming second aggregated particles in the solution containing a mixture of the dispersion A and the dispersion B is further suppressed, and thus mixing failure and abnormal aggregation between shell resin particles failing to adhere to the first aggregated particles are further reduced.

The shell resin particles may be the same as or different from the resin particles contained in the first aggregated particles. For example, from the viewpoint of adhering the shell resin to the surfaces of the first aggregated particles, the shell resin particles may be the same as the resin particles contained in the first aggregated particles.

The volume average particle diameter of the shell resin particles is preferably 0.01 μm or more and 1 μm or less, more preferably 0.08 μm or more and 0.8 μm or less, and yet more preferably 0.1 μm or more and 0.6 μm or less. The volume average particle diameter of the shell resin particles is measured by the same procedure as the volume average particle diameter of the resin particles.

The ratio of the volume average particle diameter P1 of the first aggregated particles to the volume average particle diameter P2 of the shell resin particles (P1/P2) is preferably 10 or more and 90 or less, more preferably 15 or more and 70 or less, and yet more preferably 20 or more and 50 or less.

When the ratio (P1/P2) is 10 or more, in the second aggregation step, the shell resin particles efficiently adhere to the first aggregated particles that have sufficiently aggregated and grown in the first aggregation step, and the second aggregated particles are easily formed. As a result, the coverage provided by the shell resin particles is improved, and the releasing agent surface exposure ratio further decreases in the toner particles.

When the ratio (P1/P2) is 90 or less, abnormal aggregation that involves aggregation between shell resin particles in the second aggregation step is further reduced. As a result, the coverage provided by the shell resin particles is improved, and the releasing agent surface exposure ratio further decreases in the toner particles.

The ratio (volume average particle diameter/solid component concentration (B)) of the volume average particle diameter (nm) of the shell resin particles to the solid component concentration (B) of the dispersion B is preferably 2 or more and 20 or less, more preferably 3 or more and 13 or less, and yet more preferably 4 or more and 10 or less.

When the ratio (volume average particle diameter/solid component concentration (B)) is 2 or more, compared to the combination of an excessively small volume average particle diameter of the shell resin particles and an excessively high solid component concentration (B) of the dispersion B, the shell resin particles efficiently adhere to the first aggregated particles that have sufficiently aggregated and grown in the first aggregation step, and the second aggregated particles are easily formed. As a result, the coverage provided by the shell resin particles is improved, and the releasing agent surface exposure ratio further decreases in the toner particles.

When the ratio (volume average particle diameter/solid component concentration (B)) is 20 or less, compared to the combination of an excessively large volume average particle diameter of the shell resin particles and an excessively low solid component concentration (B) of the dispersion B, local generation of a region where the first resin particle concentration is low is further suppressed in the second aggregation step, and thus the abnormal aggregation that involves aggregation between shell resin particles is further reduced. As a result, the coverage provided by the shell resin particles is improved, and the releasing agent surface exposure ratio further decreases in the toner particles.

The second aggregation step may involve, for example, mixing a dispersion A containing first aggregated particles and a dispersion B containing shell resin particles, heating the resulting mixture at a temperature equal to or lower than the glass transition temperature of the shell resin particles, and aggregating the shell resin particles onto the surfaces of the first aggregated particles to form second aggregated particles. Heating at a temperature equal to or lower than the glass transition temperature of the shell resin particles increases the efficiency of adhering the shell resin particles to the first aggregated particles compared to heating at a temperature higher than the glass transition temperature of the shell resin particles.

The heating time may be any time for which the shell resin particles aggregate onto the surfaces of the first aggregated particles, and may be, for example, 1 minute or longer and 5 hours or shorter (more preferably 5 minutes or longer and 1 hour or shorter).

The second aggregation step may involve gradually adding the dispersion B containing shell resin particles to the dispersion A. When the dispersion B is gradually added to the dispersion A, local generation of the region where the first resin particle concentration is too high is suppressed in the second aggregation step, and thus abnormal aggregation that involves aggregation between shell resin particles is further reduced compared to when the dispersion B is added all at once. As a result, the coverage provided by the shell resin particles is improved, and the releasing agent surface exposure ratio further decreases in the toner particles.

The addition rate of the dispersion B in the second aggregation step relative to 100 parts by mass of the dispersion A is preferably 0.1 parts by mass per minute or more and 1.2 parts by mass per minute or less, and more preferably 0.7 parts by mass per minute or more and 1.0 parts by mass per minute or less.

When the addition rate of the dispersion B in the second aggregation step is 0.1 parts by mass or more per minute, local generation of the region where the first resin particle concentration is too high is further suppressed in the second aggregation step, and thus abnormal aggregation that involves aggregation between shell resin particles is further reduced compared to when the addition rate is less than 0.1 parts by mass per minute (for example, when the dispersion B is added all at once). As a result, the coverage provided by the shell resin particles is improved, and the releasing agent surface exposure ratio further decreases in the toner particles.

When the addition rate of the dispersion B in the second aggregation step is 1.2 parts by mass or less per minute, the shell resin particles more efficiently adhere to the first aggregated particles and second aggregated particles are easily formed compared to when the addition rate is more than 1.2 parts by mass per minute. As a result, the coverage provided by the shell resin particles is improved, and the releasing agent surface exposure ratio further decreases in the toner particles.

The stirring rate of the reaction system in the first aggregation step and the stirring rate of the reaction system in the second aggregation step are not particularly limited, and may be the same or different; however, the stirring rate of the reaction system in the second aggregation step may be slower than the stirring rate of the reaction system in the first aggregation step. As a result, the shell resin particles more efficiently adhere to the first aggregated particles, and the second aggregated particles are easily formed.

### Fusing Step

The method for producing a toner for developing an electrostatic charge image according to this exemplary embodiment includes a fusing step.

In the fusing step, the second aggregated particles are heated and fused to form toner particles.

The fusing step may, for example, involve heating the second aggregated particle dispersion in which the second aggregated particles are dispersed to a temperature equal to or higher than the higher one selected from the glass transition temperatures of the resin particles and the shell resin particles and equal to or higher than the melting temperature of the releasing agent so as to fuse the second aggregated particles.

The temperature equal to or higher than the glass transition temperature of the resin particles is preferably a temperature that is 10° C. to 50° C. higher than the glass transition temperature of the resin particles or the shell resin particles and that is equal to or higher than the melting temperature of the releasing agent, and is more preferably a temperature that is 10° C. to 30° C. higher than the glass transition temperature of the resin particles and that is equal to or higher than the melting temperature of the releasing agent.

Heating at a temperature equal to or higher than the higher one of the glass transition temperatures of the resin particles and the shell resin particles and equal to or higher than the melting temperature of the releasing agent more efficiently fuses the resin component and the releasing agent contained in the second aggregated particles, improves coverage provided by the shell resin particles, and decreases the releasing agent surface exposure ratio in the toner particles.

The heating time may be any time for which the second aggregated particles are fused, and may be, for example, 30 minutes or longer and 10 hours or shorter (more preferably 1 hour or longer and 3 hours or shorter).

Core-shell toner particles are obtained through the aforementioned steps of the method for producing a toner for developing an electrostatic charge image according to this exemplary embodiment.

The first aggregation step, the second aggregation step, and the fusing step may be performed in the same stirring device or in different stirring devices; however, from the efficiency viewpoint, the same stirring device may be used.

### Other Steps

The method for producing a toner for developing an electrostatic charge image according to this exemplary embodiment may further include other steps in addition to the first aggregation step, the second aggregation step, and the fusing step.

Examples of other steps include a washing step, a solid-liquid separation step, a drying step, an external additive adding step, a resin particle dispersion preparation step, and a pH adjusting step.

Known techniques can be applied to the washing step, the solid-liquid separation step, and the drying step.

For example, the washing step may involve substitution-washing of the toner particle-containing solution using ion exchange water from the viewpoint of chargeability.

For example, the solid-liquid separation step may involve suction filtration, pressure filtration, or the like, from the viewpoint of productivity.

For example, the drying step may involve freeze-drying, air stream drying, flow-drying, vibrational flow drying, or the like, from the viewpoint of productivity.

In the external additive adding step, an external additive is externally added to the toner particles obtained through the steps described above.

Examples of the external addition method include external addition method that uses a V blender, a Henschel mixer, or a Loedige mixer. In the external additive adding step, if needed, coarse particles may be removed from the toner by using a vibrating sifter, air sifter, or the like.

In the dispersion preparation step, a resin particle dispersion is prepared.

The method for producing a toner for developing an electrostatic charge image according to the present exemplary embodiment may include a step of preparing a coloring agent particle dispersion containing dispersed coloring agent particles and a step of preparing a releasing agent particle dispersion containing dispersed releasing agent particles along with the resin particle dispersion containing dispersed resin particles.

The resin particle dispersion is, for example, prepared by dispersing resin particles in a dispersion medium using a surfactant or the like.

An example of the dispersion medium used for the resin particle dispersion is an aqueous medium. Examples of the aqueous medium include water such as distilled water and ion exchange water, and alcohols. These may be used alone or in combination.

Examples of the surfactant include anionic surfactants such as sulfate esters, sulfonates, phosphate esters, and soaps; cationic surfactants such as amine salts and quaternary ammonium salts; and nonionic surfactants such as polyethylene glycol, alkyl phenol-ethylene oxide adducts, and polyhydric alcohols. Among these, anionic surfactants and cationic surfactants are particularly preferable. The nonionic surfactants may be used in combination with anionic surfactants or cationic surfactants.

One surfactant may be used alone or two or more surfactants may be used in combination.

Examples of the method for dispersing resin particles in a dispersion medium in preparing the resin particle dispersion include typical dispersing methods that use a rotational shear-type homogenizer, or a mill that uses media such as a ball mill, a sand mill, or a dyno mill. Depending on the type of the resin particles, the resin particles may be dispersed in the dispersion medium by a phase inversion emulsification method. The phase inversion emulsification method is a method that involves dissolving a resin to be dispersed in a hydrophobic organic solvent that can dissolve the resin, adding a base to the organic continuous phase (0 phase) to neutralize, and then adding an aqueous medium (W phase) to the resulting mixture to perform W/O-to-O/W phase conversion and disperse the resin into particles in the aqueous medium.

The volume average particle diameter of the resin particles to be dispersed in the resin particle dispersion is, for example, preferably 0.01 μm or more and 1 μm or less, more preferably 0.08 μm or more and 0.8 μm or less, and yet more preferably 0.1 μm or more and 0.6 μm or less.

The resin particle content in the resin particle dispersion is preferably 5 mass % or more and 50 mass % or less, and more preferably 10 mass % or more and 40 mass % or less.

A coloring agent particle dispersion and a releasing agent particle dispersion are, for example, prepared as with the resin particle dispersion. In other words, the volume average particle diameter, the dispersion medium, the dispersing method, and the particle content regarding the particles in the resin particle dispersion equally apply to the coloring agent particles dispersed in the coloring agent particle dispersion and the releasing agent particles dispersed in the releasing agent particle dispersion.

In the pH adjusting step, an acid or an alkali is added after the first aggregation step or the second aggregation step to adjust the pH. Performing the pH adjusting step can control the progress of the aggregation of the first aggregated particles or the second aggregated particles.

Individual components contained in the toner for developing an electrostatic charge image according to this exemplary embodiment will now be described in detail. The toner particles contain a releasing agent and a resin component (hereinafter referred to as the binder resin) of the resin particles or the shell resin particles. The toner particles may contain other components as necessary.

### Binder Resin

The binder resin preferably contains an amorphous resin, and more preferably contains an amorphous resin and a crystalline resin.

An amorphous resin refers to a resin that exhibits only a stepwise endothermic change rather than a clear endothermic peak in thermal analysis by differential scanning calorimetry (DSC), that is solid at room temperature, and that turns thermoplastic at a temperature equal to or higher than the glass transition temperature.

A crystalline resin refers to a resin that has a clear endothermic peak rather than a stepwise endothermic change in differential scanning calorimetry (DSC).

Specifically, for example, a crystalline resin refers to a resin that has an endothermic peak having a half width of 10° C. or less when measured at a heating rate of 10° C./min, and an amorphous resin refers to a resin that has a half width exceeding 10° C. or has no clear endothermic peak.

Examples of the amorphous resin include known amorphous resins such as amorphous polyester resins, amorphous vinyl resins (for example, styrene acrylic resin), epoxy resins, polycarbonate resins, and polyurethane resins. Among these, amorphous polyester resins and amorphous vinyl resins (in particular, styrene acrylic resins) are preferable and amorphous polyester resins are more preferable. An amorphous polyester resin and a styrene acrylic resin may be used in combination as the amorphous resin.

The “crystalline” resin means that a resin has a clear endothermic peak rather than a stepwise endothermic change in differential scanning calorimetry (DSC), to be specific, that the half width of the endothermic peak as measured at a heating rate of 10 (° C./min) is within 10° C.

The “amorphous” resin means that a resin has a half width exceeding 10° C., exhibits a stepwise endothermic change, or has no clear endothermic peak.

### Amorphous Polyester Resin

Examples of the amorphous polyester resin include polycondensation products between polycarboxylic acids and polyhydric alcohols. A commercially available amorphous polyester resin or a synthesized amorphous polyester resin may be used as the amorphous polyester resin.

Examples of the polycarboxylic acids include aliphatic dicarboxylic acids (for example, oxalic acid, malonic acid, maleic acid, fumaric acid, citraconic acid, itaconic acid, glutaconic acid, succinic acid, alkenyl succinic acid, adipic acid, and sebacic acid), alicyclic dicarboxylic acids (for example, cyclohexanedicarboxylic acid), aromatic dicarboxylic acids (for example, terephthalic acid, isophthalic acid, phthalic acid, and naphthalenedicarboxylic acid), anhydrides thereof, and lower (for example, 1 to 5 carbon atoms) alkyl esters thereof. Among these, aromatic dicarboxylic acids are preferable as the polycarboxylic acids, for example.

A dicarboxylic acid and a tri- or higher carboxylic acid having a crosslinked structure or a branched structure may be used in combination as the polycarboxylic acid. Examples of the tri- or higher carboxylic acid include trimellitic acid, pyromellitic acid, anhydrides thereof, and lower (for example, 1 to 5 carbon atoms) alkyl esters thereof.

These polycarboxylic acids may be used alone or in combination.

Examples of the polyhydric alcohols include aliphatic diols (for example, ethylene glycol, diethylene glycol, triethylene glycol, propylene glycol, butanediol, hexanediol, and neopentyl glycol), alicyclic diols (for example, cyclohexanediol, cyclohexanedimethanol, and hydrogenated bisphenol A), and aromatic diols (for example, ethylene oxide adducts of bisphenol A and propylene oxide adducts of bisphenol A). Among these, aromatic diols and alicyclic diols are preferred, and aromatic diols are more preferred as the polyhydric alcohol.

A trihydric or higher alcohol having a crosslinked structure or a branched structure may be used in combination with a diol as the polyhydric alcohol. Examples of the trihydric or higher alcohol include glycerin, trimethylolpropane, and pentaerythritol.

These polyhydric alcohols may be used alone or in combination.

The amorphous polyester resin is obtained by a known production method. Specifically, the amorphous polyester resin is obtained by a method that involves, for example, setting the polymerization temperature to 180° C. or higher and 230° C. or lower, depressurizing the inside of the reaction system as necessary, and performing reaction while removing water and alcohol generated during the condensation. When the monomers of the raw materials do not dissolve or mix at the reaction temperature, a high-boiling-point solvent may be added as a dissolving aid. In such a case, the polycondensation reaction is performed while distilling away the dissolving aid. When a poorly compatible monomer is present in the copolymerization reaction, this monomer may be preliminarily condensed with an acid or an alcohol for which the polycondensation with that monomer is planned, and then polycondensation may be performed with other components.

An example of the binder resin, in particular, the amorphous resin, is a styrene acrylic resin.

A styrene acrylic resin is a copolymer obtained by copolymerizing at least a styrene monomer (a monomer having a styrene skeleton) and a (meth)acrylic monomer (a monomer having a (meth)acryl group, preferably, a monomer having a (meth)acryloxy group). The styrene acrylic resin includes, for example, a copolymer of a styrene monomer and a (meth)acrylate monomer.

The acrylic resin moiety in the styrene acrylic resin is a partial structure obtained by polymerizing one or both of an acrylic monomer and a methacrylic monomer. The term “(meth)acryl” includes both “acryl” and “methacryl”.

Specific examples of the styrene monomer include styrene, alkyl-substituted styrene (for example, α-methylstyrene, 2-methylstyrene, 3-methylstyrene, 4-methylstyrene, 2-ethylstyrene, 3-ethylstyrene, and 4-ethylstyrene), halogen-substituted styrene (for example, 2-chlorostyrene, 3-chlorostyrene, and 4-chlorostyrene), and vinylnaphthalene. These styrene monomers may be used alone or in combination.

Among these, styrene can be used as the styrene monomer from the viewpoints of ease of reaction, ease of controlling the reaction, and availability.

Specific examples of the (meth)acrylic monomer include (meth)acrylic acid and (meth)acrylates. Examples of the (meth)acrylates include (meth)acrylic acid alkyl esters (for example, methyl (meth)acrylate, ethyl (meth)acrylate, n-propyl (meth) acrylate, n-butyl (meth) acrylate, n-pentyl (meth)acrylate, n-hexyl acrylate, n-heptyl (meth)acrylate, n-octyl (meth)acrylate, n-decyl (meth)acrylate, n-dodecyl (meth) acrylate, n-lauryl (meth) acrylate, n-tetradecyl (meth) acrylate, n-hexadecyl (meth) acrylate, n-octadecyl (meth)acrylate, isopropyl (meth)acrylate, isobutyl (meth)acrylate, t-butyl (meth)acrylate, isopentyl (meth)acrylate, amyl (meth)acrylate, neopentyl (meth)acrylate, isohexyl (meth)acrylate, isoheptyl (meth) acrylate, isooctyl (meth) acrylate, 2-ethylhexyl (meth)acrylate, cyclohexyl (meth)acrylate, and t-butylcyclohexyl (meth)acrylate), (meth)acrylic acid aryl esters (for example, phenyl (meth)acrylate, biphenyl (meth) acrylate, diphenylethyl (meth) acrylate, t-butylphenyl (meth)acrylate, and terphenyl (meth)acrylate), dimethylaminoethyl (meth) acrylate, diethylaminoethyl (meth) acrylate, methoxyethyl (meth) acrylate, 2-hydroxyethyl (meth)acrylate, β-carboxyethyl (meth)acrylate, and (meth)acrylamide. These (meth)acrylic acid monomers may be used alone or in combination.

Among (meth)acrylates among these (meth)acrylic monomers, (meth)acrylates having an alkyl group having 2 to 14 carbon atoms (preferably 2 to 10 carbon atoms and more preferably 3 to 8 carbon atoms) are preferable from the viewpoint of fixability.

In particular, n-butyl (meth)acrylate is preferable, and n-butyl acrylate is more preferable.

The copolymerization ratio of the styrene monomer to the (meth)acrylic monomer (mass basis, styrene monomer/(meth)acrylic monomer) is not particularly limited and can be 85/15 to 70/30.

The styrene acrylic resin may have a crosslinked structure. An example of the styrene acrylic resin having a crosslinked structure is a resin obtained by copolymerizing at least a styrene monomer, a (meth)acrylic acid monomer, and a crosslinking monomer.

Examples of the crosslinking monomer include difunctional or higher crosslinking agents.

Examples of the difunctional crosslinking agent include divinylbenzene, divinylnaphthalene, di(meth)acrylate compounds (for example, diethylene glycol di(meth)acrylate, methylenebis(meth)acrylamide, decanediol diacrylate, and glycidyl (meth)acrylate), polyester-type di(meth)acrylate, 2-([1′-methylpropylideneamino]carboxyamino)ethyl methacrylate.

Examples of the polyfunctional crosslinking agent include tri(meth)acrylate compounds (for example, pentaerythritol tri(meth)acrylate, trimethylolethane tri(meth)acrylate, and trimethylolpropane tri(meth)acrylate), tetra(meth)acrylate compounds (for example, pentaerythritol tetra(meth)acrylate and oligo ester (meth)acrylate), 2,2-bis(4-methacryloxy, polyethoxyphenyl)propane, diallyl phthalate, triallyl cyanurate, triallyl isocyanurate, triallyl trimellitate, and diallyl chlorendate.

In particular, from the viewpoints of fixability and suppressing degradation of the image density and generation of image density variation, the crosslinking monomer is preferably a difunctional or higher (meth)acrylate compound, more preferably a difunctional (meth)acrylate compound, yet more preferably a difunctional (meth)acrylate compound having an alkylene group having 6 to 20 carbon atoms, and particularly preferably a difunctional (meth)acrylate compound having a linear alkylene group having 6 to 20 carbon atoms.

The copolymerization ratio of the crosslinking monomer relative to all monomers (mass basis, crosslinking monomer/all monomers) is not particularly limited and can be 2/1,000 to 20/1,000.

The method for preparing the styrene acrylic resin is not particularly limited, and various polymerization methods (for example, solution polymerization, precipitation polymerization, suspension polymerization, bulk polymerization, and emulsification polymerization) are applied. Known processes (for example, batch, semi-continuous, and continuous methods) are applied to the polymerization reaction.

The styrene acrylic resin preferably accounts for 0 mass % or more and 20 mass % or less, more preferably 1 mass % or more and 15 mass % or less, and yet more preferably 2 mass % or more and 10 mass % or less of the entire binder resin.

The amorphous resin preferably accounts for 60 mass % or more and 98 mass % or less, more preferably 65 mass % or more and 95 mass % or less, and yet more preferably 70 mass % or more and 90 mass % or less of the entire binder resin.

The properties of the amorphous resin will now be described.

The glass transition temperature (Tg) of the amorphous resin is preferably 50° C. or higher and 80° C. or lower and more preferably 50° C. or higher and 65° C. or lower.

The glass transition temperature is determined from a DSC curve obtained by differential scanning calorimetry (DSC), more specifically, according to “extrapolated glass transition onset temperature” described in the method for determining the glass transition temperature in JIS K 7121:1987 “Testing Methods for Transition Temperatures of Plastics”.

The weight average molecular weight (Mw) of the amorphous resin is preferably 5,000 or more and 1,000,000 or less and more preferably 7,000 or more and 500,000 or less.

The number average molecular weight (Mn) of the amorphous resin can be 2,000 or more and 100,000 or less.

The molecular weight distribution Mw/Mn of the amorphous resin is preferably 1.5 or more and 100 or less and more preferably 2 or more and 60 or less.

The weight average molecular weight and the number average molecular weight are measured by gel permeation chromatography (GPC). The molecular weight measurement by GPC is conducted by using GPCHLC-8120GPC produced by TOSOH CORPORATION as a measuring instrument with columns TSKgel Super HM-M (15 cm) produced by TOSOH CORPORATION, and a THF solvent. The weight average molecular weight and the number average molecular weight are calculated from the measurement results by using the molecular weight calibration curves obtained from monodisperse polystyrene standard samples.

The crystalline resin will now be described.

Examples of the crystalline resin include known crystalline resins such as a crystalline polyester resin and a crystalline vinyl resin (for example, a polyalkylene resin and a long chain alkyl (meth)acrylate resin). Among these, a crystalline polyester resin can be used.

### Crystalline Polyester Resin

Examples of the crystalline polyester resin include polycondensation products between polycarboxylic acids and polyhydric alcohols. A commercially available crystalline polyester resin or a synthesized crystalline polyester resin may be used as the crystalline polyester resin.

To smoothly form a crystal structure, the crystalline polyester resin can be a polycondensation product obtained by using a linear aliphatic polymerizable monomer rather than a polymerizable monomer having an aromatic ring.

Examples of the polycarboxylic acids include aliphatic dicarboxylic acids (for example, oxalic acid, succinic acid, glutaric acid, adipic acid, suberic acid, azelaic acid, sebacic acid, 1,9-nonandicarboxylic acid, 1,10-decandicarboxylic acid, 1,12-dodecandicarboxylic acid, 1,14-tetradecanedicarboxylic acid, and 1,18-octadecanedicarboxylic acid), aromatic dicarboxylic acids (for example, dibasic acids such as phthalic acid, isophthalic acid, terephthalic acid, and naphthalene-2,6-dicarboxylic acid), anhydrides thereof, and lower (for example, 1 to 5 carbon atoms) alkyl esters thereof.

A dicarboxylic acid and a tri- or higher carboxylic acid having a crosslinked structure or a branched structure may be used in combination as the polycarboxylic acid. Examples of the tricarboxylic acid include aromatic carboxylic acids (for example, 1,2,3-benzenetricarboxylic acid, 1,2,4-benzenetricarboxylic acid, and 1,2,4-naphthalenetricarboxylic acid), anhydrides thereof, and lower (for example, 1 to 5 carbon atoms) alkyl esters thereof.

As the polycarboxylic acid, any of these dicarboxylic acids may be used in combination with a dicarboxylic acid having a sulfonic acid group and a dicarboxylic acid having an ethylenic double bond.

These polycarboxylic acids may be used alone or in combination.

Examples of the polyhydric alcohol include aliphatic diols (for example, linear aliphatic diols having a main chain moiety having 7 to 20 carbon atoms). Examples of the aliphatic diols include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,14-icosanediol. Among these, 1,8-octanediol, 1,9-nonanediol, and 1,10-decanediol are preferable as the aliphatic diols.

A diol and a trihydric or higher alcohol having a crosslinked structure or a branched structure may be used in combination as the polyhydric alcohol. Examples of the trihydric or higher alcohol include glycerin, trimethylolethane, trimethylolpropane, and pentaerythritol.

These polyhydric alcohols may be used alone or in combination.

The polyhydric alcohol preferably has an aliphatic diol content of 80 mol % or more and more preferably 90 mol % or more.

The melting temperature of the crystalline polyester resin is preferably 50° C. or higher and 100° C. or lower, more preferably 55° C. or higher and 90° C. or lower, and yet more preferably 60° C. or higher and 85° C. or lower.

Here, the melting temperature is determined from a differential scanning calorimetry (DSC) curve obtained by DSC in accordance with “Melting peak temperature” described in the method for determining the melting temperature in JIS K 7121:1987 “Testing Methods for Transition Temperatures of Plastics”.

The weight-average molecular weight (Mw) of the crystalline polyester resin may be 6,000 or more and 35,000 or less.

The crystalline polyester resin is, for example, obtained by a known production method as with the amorphous polyester resin.

The crystalline resin preferably accounts for 1 mass % or more and 20 mass % or less, more preferably 2 mass % or more and 15 mass % or less, and yet more preferably 3 mass % or more and 10 mass % or less of the entire binder resin.

The binder resin content relative to the entire toner particles is preferably 40 mass % or more and 95 mass % or less, more preferably 50 mass % or more and 90 mass % or less, and yet more preferably 60 mass % or more and 85 mass % or less.

### Releasing Agent

Examples of the releasing agent include hydrocarbon wax; natural wax such as carnauba wax, rice wax, and candelilla wax; synthetic or mineral or petroleum wax such as montan wax; and ester wax such as fatty acid esters and montanic acid esters.

When the resin particles contain an amorphous polyester resin, the releasing agent may be an ester wax, which has good compatibility with the amorphous polyester resin, from the viewpoint of further improving the image density stability.

An ester was is a wax that has an ester bond. The ester wax may be a monoester, a diester, a triester, or a tetraester, and a known natural or synthetic ester wax can be employed.

Examples of the ester wax include ester compounds formed between higher aliphatic acids (aliphatic acids having 10 or more carbon atoms etc.) and monohydric or polyhydric aliphatic alcohols (aliphatic alcohols having 8 or more carbon atoms etc.) and having a melting point of 60° C. or higher and 110° C. or lower (preferably 65° C. or higher and 100° C. or lower and more preferably 70° C. or higher and 95° C. or lower).

Examples of the ester wax include ester compounds obtained from higher aliphatic acids (caprylic acid, capric acid, lauric acid, myristic acid, palmitic acid, stearic acid, arachidic acid, behenic acid, oleic acid, etc.) and alcohols (monohydric alcohols such as methanol, ethanol, propanol, isopropanol, butanol, capryl alcohol, lauryl alcohol, myristyl alcohol, cetyl alcohol, stearyl alcohol, and oleyl alcohol; and polyhydric alcohols such as glycerin, ethylene glycol, propylene glycol, sorbitol, and pentaerythritol), and specific examples of the ester wax include carnauba wax, rice wax, candelilla wax, jojoba wax, wood wax, beeswax, privet wax, lanolin, and montanic acid ester wax.

Among those described above, carnauba wax is difficult to form wax domains, and thus the toner surface exposure ratio tends to be high in producing the toner; however, according to the toner production method of the exemplary embodiment, the releasing agent surface exposure ratio can be decreased even when this carnauba wax is used.

The melting temperature of the releasing agent is preferably 50° C. or higher and 110° C. or lower and more preferably 60° C. or higher and 100° C. or lower.

The melting temperature of the releasing agent is determined from a differential scanning calorimetry (DSC) curve obtained by DSC in accordance with “Melting peak temperature” described in the method for determining the melting temperature in JIS K 7121:1987 “Testing Methods for Transition Temperatures of Plastics”.

The releasing agent content relative to the entire toner particles is preferably 1 mass % or more and 20 mass % or less and more preferably 5 mass % or more and 15 mass % or less.

The releasing agent content relative to the entire toner particles is, for example, preferably 1 mass % or more and 20 mass % or less and more preferably 5 mass % or more and 15 mass % or less.

### Other Additives

Examples of other additives include known additives such as magnetic materials, charge controllers, and inorganic powders. These additives are contained in the toner particles as internal additives.

### Coloring Agent

Examples of the coloring agent include various pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, dupont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; and dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

These coloring agents may be used alone or in combination.

The coloring agent may be surface-treated as necessary, or may be used in combination with a dispersing agent. Multiple coloring agents may be used in combination.

The coloring agent content relative to the entire toner particles is, for example, preferably 1 mass % or more and 30 mass % or less and more preferably 3 mass % or more and 15 mass % or less.

### Properties and Other Features of Toner Particles

The toner particles have a core-shell structure that has a core (core particle) and a coating layer (shell layer) that covers the surface of the core. The core-shell toner particles may be constituted by, for example, a core (in other words, the first aggregated particle) containing at least a binder resin (in other words, resin particles) and a releasing agent (in other words, releasing agent particles) and, if needed, other additives such as a coloring agent, and a coating layer containing a binder resin (in other words, shell resin particles).

The volume average particle diameter (D50v) of the toner particles is preferably 2 μm or more and 10 μm or less and more preferably 4 μm or more and 8 μm or less.

Various volume average particle diameters and various particle size distribution indices of the toner particles are measured with Coulter Multisizer II (produced by Beckman Coulter Inc.) with ISOTON-II (produced by Beckman Coulter Inc.) as the electrolyte.

In measurement, 0.5 mg or more and 50 mg of a measurement sample is added to 2 mL of a 5% aqueous solution of a surfactant (for example, sodium alkylbenzene sulfonate) serving as a dispersing agent. The resulting mixture is added to 100 mL or more and 150 mL of the electrolyte.

The electrolyte in which the sample has been suspended is dispersed with an ultrasonic disperser for 1 minute, and the particle size distribution of the particles having a particle diameter in the range of 2 μm or more and 60 μm or less is measured by using Coulter Multisizer II (produced by Beckman Coulter Inc.) with a 100 μm aperture. The number of particles sampled is 50000.

Relative to the particle size ranges (channels) divided on the basis of the particle size distribution to be measured, the volume and the number are plotted from the small diameter side to draw cumulative distributions. The particle diameters at a cumulative percentage of 16% are defined to be a volume particle diameter D16v and a number particle diameter D16p, the particle diameters at a cumulative percentage of 50% are defined to be a volume average particle diameter D50v and cumulative number-average particle diameter D50p, and the particle diameters at a cumulative percentage of 84% are defined to be the volume particle diameter D84v and the number particle diameter D84p.

These results are used to calculate the volume particle size distribution index (GSDv) as (D84v/D16v)^{1/2} and the number particle size distribution index (GSDp) as (D84p/D16p)^{1/2}.

The average circularity of the toner particles is preferably 0.94 or more and 1.00 or less and more preferably 0.95 or more and 0.98 or less.

The average circularity of the toner particles is determined from (circle-equivalent perimeter)/(perimeter) [(perimeter of a circle having the same projection area as the particle image)/(perimeter of a particle projection image)]. Specifically, it is the value measured by the following method.

First, toner particles to be measured are sampled by suction, and are allowed to form a flat flow. Particle images are captured as still images by performing instantaneous strobe light emission, and these particle images are analyzed by a flow-type particle image analyzer (FPIA-3000 produced by Sysmex Corporation) to determine the average circularity. In determining the average circularity, 3500 particles are sampled.

When the toner contains an external additive, the toner (developer) to be measured is dispersed in surfactant-containing water, and then ultrasonically treated to obtain toner particles from which the external additive has been removed.

### External Additive

A toner produced by the method for producing a toner for developing an electrostatic charge image according to the exemplary embodiment may further contain an external additive if needed.

Furthermore, the toner produced by the method for producing a toner for developing an electrostatic charge image according to the exemplary embodiment may be free of external additives or may contain an external additive externally added to the toner particles.

An example of the external additive is inorganic particles. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO·SiO₂, K₂O·(TiO₂) n, Al₂O₃·2SiO₂, CaCO₃, MgCO₃, BaSO₄, and MgSO₄.

Among these, an external additive that has a relatively large particle diameter increases the stress generated by collision between particles; thus, such an external additive easily sinks into the toner particle surfaces, and the thermal stability and the image density stability tend to be degraded. However, according to the toner production method of the exemplary embodiment, the external additive does not easily sink into the toner particle surfaces even when the particle diameter thereof is relatively large, and thus the releasing agent surface exposure ratio is decreased, and the thermal stability and the image density stability are improved.

The surfaces of the inorganic particles serving as an external additive may be hydrophobized. The hydrophobizing treatment involves, for example, immersing inorganic particles in a hydrophobizing agent. The hydrophobizing agent is not particularly limited, and examples thereof include silane coupling agents, silicone oil, titanate coupling agents, and aluminum coupling agents. These may be used alone or in combination.

The amount of the hydrophobizing agent may be 1 part by mass or more and 10 parts by mass or less relative to 100 parts by mass of the inorganic particles, for example.

Examples of the external additive also include resin particles (resin particles such as polystyrene, polymethyl methacrylate (PMMA), and melamine resin), and cleaning activating agents (for example, particles of metal salts of higher fatty acids such as zinc stearate, and particles of fluorine polymers).

The amount of the external additive externally added relative to the toner particles is, for example, preferably 0.01 mass % or more and 5 mass % or less and more preferably 0.01 mass % or more and 2.0 mass % or less.

### Electrostatic Charge Image Developer

An electrostatic charge image developer according to an exemplary embodiment contains at least a toner produced by the method for producing a toner for developing an electrostatic charge image of this exemplary embodiment.

The electrostatic charge image developer of this exemplary embodiment may be one-component toner containing only the toner produced by the method for producing a toner for developing an electrostatic charge image of the present exemplary embodiment, or a two-component developer that is a mixture of the toner and a carrier.

The carrier is not particularly limited and may be any known carrier. Examples of the carrier include a coated carrier obtained by covering a surface of a core formed of a magnetic powder with a coating resin; a magnetic powder-dispersed carrier in which a magnetic powder is dispersed and blended in a matrix resin; and a resin-impregnated carrier in which a porous magnetic powder is impregnated with a resin.

The magnetic powder-dispersed carrier and the resin-impregnated carrier may each be constituted by a core formed of a constituent particle of the carrier, and a coating resin covering the core.

Examples of the magnetic powder include magnetic metals such as iron, nickel, and cobalt, and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylate copolymer, an organosiloxane bond-containing straight silicone resin and modified products thereof, a fluororesin, polyester, polycarbonate, phenolic resin, and epoxy resin.

The coating resin and the matrix resin may each contain other additives such as conductive particles.

Examples of the conductive particles include particles of metals such as gold, silver, and copper, and particles of carbon black, titanium oxide, zinc oxide, tin oxide, barium sulfate, aluminum borate, and potassium titanate.

Here, an example of the method for coating the surface of the core with a resin include a method that involves coating the surface of the core with a coating layer-forming solution prepared by dissolving a coating resin and, if needed, various additives in an appropriate solvent. The solvent is not particularly limited, and may be selected in view of the type of the coating resin used, application suitability, etc.

Specific examples of the resin coating method include a dipping method that involves dipping a core in a coating layer-forming solution, a spraying method that involves spraying a coating layer-forming solution onto the surface of the core, a flow bed method that involves spraying a coating layer-forming solution while the core floats on flowing air, and a kneader coater method that involves mixing the core for the carrier and a coating layer-forming solution in a kneader coater and removing the solvent.

The toner-to-carrier mixing ratio (mass ratio) in the two-component developer is preferably 1:100 to 30:100, and more preferably 3:100 to 20:100.

### Image Forming Apparatus and Image Forming Method

An image forming apparatus and an image forming method according to exemplary embodiments will now be described.

An image forming apparatus according to an exemplary embodiment includes an image bearing member, a charging unit that charges a surface of the image bearing member, an electrostatic charge image forming unit that forms an electrostatic charge image on the charged surface of the image bearing member, a developing unit that stores an electrostatic charge image developer and develops the electrostatic charge image on the surface of the image bearing member into a toner image by using the electrostatic charge image developer, a transfer unit that transfers the toner image on the surface of the image bearing member onto a surface of a recording medium, and a fixing unit that fixes the transferred toner image on the surface of the recording medium. The electrostatic charge image developer of the present exemplary embodiment is employed as the electrostatic charge image developer.

The image forming apparatus of the present exemplary embodiment is used to implement an image forming method (the image forming method of the present exemplary embodiment) that involves a charging step of charging a surface of an image bearing member, an electrostatic charge image forming step of forming an electrostatic charge image on the charged surface of the image bearing member, a developing step of developing the electrostatic charge image on the surface of the image bearing member into a toner image by using the electrostatic charge image developer of the exemplary embodiment, a transfer step of transferring the toner image on the surface of the image bearing member onto a surface of a recording medium, and a fixing step of fixing the transferred toner image on the surface of the recording medium.

The image forming apparatus of the present exemplary embodiment may be, for example, a known image forming apparatus such as a direct transfer type apparatus with which a toner image formed on a surface of an image bearing member is directly transferred onto a recording medium; an intermediate transfer type apparatus with which a toner image formed on a surface of an image bearing member is first transferred onto a surface of an intermediate transfer body and then the toner image on the intermediate transfer body is transferred for the second time onto a surface of a recording medium; an apparatus equipped with a cleaning unit that cleans the surface of an image bearing member after the transfer of the toner image and before charging; or an apparatus equipped with a charge erasing unit that irradiates the surface of an image bearing member with charge erasing light to remove charges after the transfer of the toner image and before charging.

In particular, an image forming apparatus equipped with a cleaning unit that cleans the surface of the image bearing member is preferable. The cleaning unit may be a cleaning blade.

When the intermediate transfer type apparatus is used, the transfer unit has a structure that includes an intermediate transfer body having a surface that receives the transfer of a toner image, a first transfer unit that performs first transfer of transferring the toner image on the surface of the image bearing member onto a surface of the intermediate transfer body, and a second transfer unit that performs second transfer of transferring the transferred toner image on the surface of the intermediate transfer body onto a surface of a recording medium.

In the image forming apparatus of the present exemplary embodiment, for example, a portion that includes the developing unit may have a cartridge structure (process cartridge) detachably attachable to the image forming apparatus. An example of the process cartridge is a process cartridge equipped with a developing unit that stores the electrostatic charge image developer of the exemplary embodiment.

Hereinafter, one example of the image forming apparatus of the exemplary embodiment is described, but this exemplary embodiment is not limiting. Only the relevant parts in the drawing are described, and descriptions for other parts are omitted.

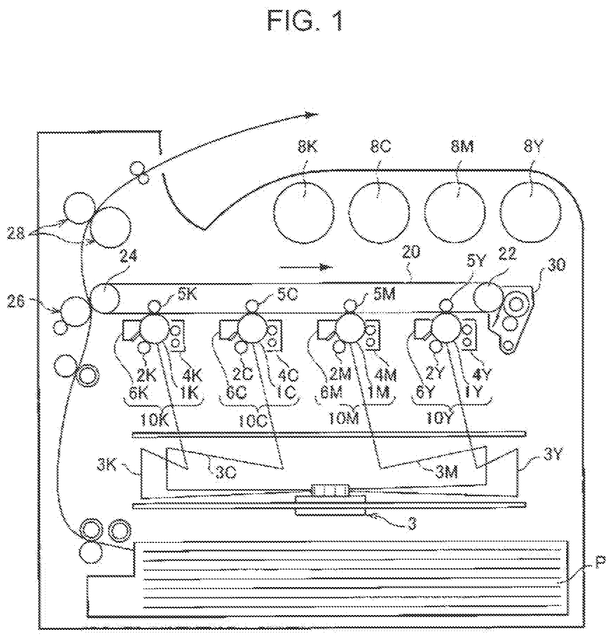

FIG. 1 is a schematic diagram illustrating an image forming apparatus according to an exemplary embodiment.

An image forming apparatus illustrated in FIG. 1 is equipped with electrophotographic first to fourth image forming units 10Y, 10M, 10C, and 10K (image forming units) that output images of respective colors, yellow (Y), magenta (M), cyan (C), and black (K), on the basis of the color separated image data. These image forming units (hereinafter may be simply referred to as “units”) 10Y, 10M, 10C, and 10K are spaced from one another by predetermined distances in the horizontal direction and arranged side-by-side. The units 10Y, 10M, 10C, and 10K may be process cartridges detachably attachable to the image forming apparatus.

An intermediate transfer belt 20 serving as an intermediate transfer body extends above all of the units 10Y, 10M, 10C, and 10K in the drawing. The intermediate transfer belt 20 is wound around a driving roll 22 and a supporting roll 24 arranged to be spaced from each other in the left-to-right direction in the drawing, and runs in the direction from the first unit 10Y toward the fourth unit 10K. The supporting roll 24 is urged to be away from the driving roll 22 by a spring or the like not illustrated in the drawing, so that a tension is applied to the intermediate transfer belt 20 wound around the two rolls. An intermediate transfer body cleaning device 30 that opposes the driving roll 22 is disposed on the image-bearing-member-side surface of the intermediate transfer belt 20.

In addition, toners of four colors, yellow, magenta, cyan, and black, are supplied from toner cartridges 8Y, 8M, 8C, and 8K to developing devices (developing units) 4Y, 4M, 4C, and 4K of the units 10Y, 10M, 10C, and 10K.

Since the first to fourth units 10Y, 10M, 10C, and 10K are identical in structure, the first unit 10Y that is disposed on the upstream side in the intermediate transfer belt running direction and forms a yellow image is described as a representative example. The parts equivalent to those of the first unit 10Y are represented by the same reference sign followed by magenta (M), cyan (C), or black (K) instead of yellow (Y), and descriptions of the second to fourth units 10M, 10C, and 10K are omitted.

The first unit 10Y includes a photoreceptor 1Y that serves as an image bearing member. The photoreceptor 1Y are surrounded by, in order of arrangement, a charging roll (one example of the charging unit) 2Y that charges a surface of the photoreceptor 1Y to a predetermined potential, an exposing device (one example of the electrostatic charge image forming unit) 3 that exposes the charged surface of the photoreceptor 1Y with a laser beam 3Y on the basis of the color-separated image signal so as to form an electrostatic charge image, a developing device (one example of the developing unit) 4Y that develops the electrostatic charge image by supplying a charged toner to the electrostatic charge image, a first transfer roll (one example of the first transfer unit) 5Y that transfers the developed toner image onto the intermediate transfer belt 20, and a cleaning device (one example of the cleaning unit) 6Y that removes the toner remaining on the surface of the photoreceptor 1Y after the first transfer.

The first transfer roll 5Y is disposed on the inner side of the intermediate transfer belt 20 and positioned to oppose the photoreceptor 1Y. Furthermore, bias power supplies (not illustrated) that apply first transfer biases are respectively connected to the first transfer rolls 5Y, 5M, 5C, and 5K. A controller not illustrated in the drawing controls each of the bias power supplies so that the transfer bias applied to the first transfer roll is variable.

Hereinafter, operation of forming a yellow image in the first unit 10Y is described.

First, before starting operation, the surface of the photoreceptor 1Y is charged by the charging roll 2Y to a potential in the range of −600 V to −800 V.

The photoreceptor 1Y is formed by stacking a photosensitive layer on a conductive (for example, volume resistivity at 20° C.: 1×10⁻⁶ Ωcm or less) base. This photosensitive layer normally has a high resistance (a resistance of a general resin); however, once irradiated with a laser beam 3Y, the portion exposed to the laser beam exhibits a change in resistivity. Next, the charged surface of the photoreceptor 1Y is irradiated with a laser beam 3Y emitted from the exposing device 3 on the basis of the yellow image data transmitted from a controller not illustrated in the drawings. The photosensitive layer constituting the surface of the photoreceptor 1Y is irradiated with the laser beam 3Y, and an electrostatic charge image having a yellow image pattern is thereby formed on the surface of the photoreceptor 1Y.

An electrostatic charge image is an image formed on the surface of the photoreceptor 1Y as a result of charging, and is a negative latent image formed as the decrease in the resistivity of the portion of the photosensitive layer irradiated with the laser beam 3Y causes the charges to flow out from the surface of the photoreceptor 1Y while the charges in the portions not irradiated with the laser beam 3Y remain.

The electrostatic charge image formed on the photoreceptor 1Y is rotated to a predetermined developing position as the photoreceptor 1Y is run. At that developing position, the electrostatic charge image on the photoreceptor 1Y is visualized by the developing device 4Y into a toner image (developed image).

The developing device 4Y stores an electrostatic charge image developer that contains at least a yellow toner and a carrier. The yellow toner is frictionally charged by being stirred in the developing device 4Y, and is held on the developer roll (one example of the developer carrying member) while the yellow toner has charges of the same polarity (negative polarity) as the charges on the photoreceptor 1Y. As the surface of the photoreceptor 1Y passes the developing device 4Y, the yellow toner electrostatically adheres to the latent image portion from which the charges on the surface of the photoreceptor 1Y have been removed, and the latent image is developed with the yellow toner. The photoreceptor 1Y on which the yellow toner image is formed is continuously run at a predetermined speed, and the developed toner image on the photoreceptor 1Y is conveyed to a predetermined first transfer position.

Once the yellow toner image on the photoreceptor 1Y is conveyed to the first transfer position, a first transfer bias is applied to the first transfer roll 5Y, an electrostatic force acting from the photoreceptor 1Y toward the first transfer roll 5Y acts on the toner image, and the toner image on the photoreceptor 1Y is transferred onto the intermediate transfer belt 20. The transfer bias applied here has a polarity (+) opposite to the polarity (−) of the toner, and, in the first unit 10Y, for example, is controlled at +10 μA by a controller (not illustrated).

Meanwhile, the toner remaining on the photoreceptor 1Y is removed by the photoreceptor cleaning device 6Y and recovered.

The first transfer biases applied to the first transfer rolls 5M, 5C, and 5K of the second unit 10M and onwards are also controlled as with the first unit.

The intermediate transfer belt 20, onto which a yellow toner image is transferred in the first unit 10Y, sequentially passes the second to fourth units 10M, 10C, and 10K, and toner images of respective colors are stacked on top of each other to perform multilayer transfer.

After the multilayer transfer of toner images of four colors through the first to fourth units, the intermediate transfer belt 20 reaches a second transfer portion constituted by the intermediate transfer belt 20, the supporting roll 24 in contact with the inner surface of the intermediate transfer belt 20, and a second transfer roll (one example of the second transfer unit) 26 disposed on the image-retaining-surface-side of the intermediate transfer belt 20. Meanwhile, a recording sheet (one example of the recording medium) P is fed, via a feeder mechanism, to a contact gap between the second transfer roll 26 and the intermediate transfer belt 20 at a predetermined timing, and a second transfer bias is applied to the supporting roll 24. The transfer bias applied here has the same polarity (−) as the polarity o(−) of the toner, an electrostatic force from the intermediate transfer belt 20 acting toward the recording sheet P acts on the toner images, and the toner images on the intermediate transfer belt 20 are transferred onto the recording sheet P. Here, the second transfer bias is determined according to the resistance of the second transfer portion detected by a resistance detection unit (not illustrated), and is controlled by voltage.

Subsequently, the recording sheet P is conveyed to a contact portion (nip portion) of a pair of fixing rolls in a fixing device (one example of the fixing unit) 28 where the toner images are fixed to the recording sheet P and a fixed image is formed.

Examples of the recording sheet P onto which the toner images are transferred include regular paper used in electrophotographic copiers and printers. Examples of the recording medium also include OHP sheets and the like in addition of the recording sheet P.

In order to further improve the smoothness of the image surface after fixing, the surface of the recording sheet P may be smooth. For example, coated paper obtained by coating the surface of regular paper with a resin or the like, art paper for printing, and the like may be used.

After completion of fixing of the color image, the recording sheet P is conveyed toward a discharge portion, and a series of color image forming operation steps are completed.

### Process Cartridge and Toner Cartridge

A process cartridge according to an exemplary embodiment will now be described.

The process cartridge according to this exemplary embodiment is detachably attachable to an image forming apparatus, and includes a developing unit that stores the electrostatic charge image developer of the exemplary embodiment and develops an electrostatic charge image on a surface of an image bearing member into a toner image by using the electrostatic charge image developer.

The process cartridge of the exemplary embodiment is not limited to the aforementioned structure, and may include a developing device and, if needed, at least one unit selected from an image bearing member, a charging unit, an electrostatic charge image forming unit, transfer unit, and other units, for example.

Hereinafter, one example of the process cartridge of the exemplary embodiment is described, but this example is not limiting. Only the relevant parts in the drawing are described, and descriptions for other parts are omitted.

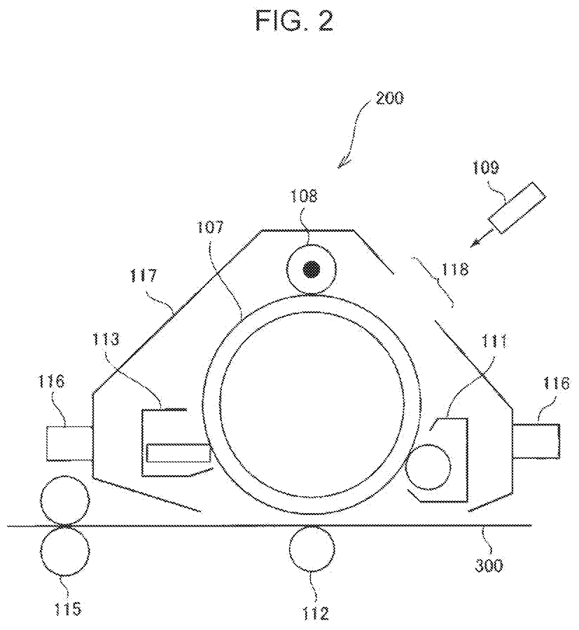

FIG. 2 is a schematic diagram illustrating a process cartridge according to an exemplary embodiment.

A process cartridge 200 illustrated in FIG. 2 is, for example, a cartridge obtained by using a housing 117 equipped with a guide rail 116 and an exposure opening 118 so as to integrate a photoreceptor 107 (one example of the image bearing member), and a charging roll 108 (one example of the charging unit), a developing device 111 (one example of the developing unit), and a photoreceptor cleaning device 113 (one example of the cleaning unit) provided around the photoreceptor 107.

In FIG. 2, 109 denotes an exposure device (one example of the electrostatic charge image forming unit), 112 denotes a transfer device (one example of the transfer unit), 115 denotes a fixing device (one example of the fixing unit), and 300 denotes a recording sheet (one example of the recording medium).

Next, a toner cartridge according to an exemplary embodiment is described.

The toner cartridge according to this exemplary embodiment stores the toner of the exemplary embodiment and is detachably attachable to an image forming apparatus. The toner cartridge stores replenishing toner to be supplied to a developing unit disposed inside the image forming apparatus.

Note that the image forming apparatus illustrated in FIG. 1 has detachably attachable toner cartridges 8Y, 8M, 8C, and 8K that are respectively connected to the developing devices 4Y, 4M, 4C, and 4K of the corresponding colors via toner supply tubes not illustrated in the drawing. In addition, when the toner level in the toner cartridge has run low, the cartridge is replaced.

### EXAMPLES

Hereinafter, the exemplary embodiments are specifically described in further details through examples and comparative examples but are not limited by these examples in any way. In the description below, “parts” and “%” are on a mass basis unless otherwise noted.

### Synthesis of Polyester Resin

Into a reactor equipped with a stirrer, a thermometer, a condenser, and a nitrogen gas inlet tube, 80 molar parts of polyoxypropylene(2,2)-2,2-bis(4-hydroxyphenyl)propane, 10 molar parts of ethylene glycol, 10 molar parts of cyclohexanediol, 80 molar parts of terephthalic acid, 10 molar parts of isophthalic acid, and 10 molar parts of n-dodecenylsuccinic acid are charged, and the inside of the reactor is purged with dry nitrogen gas. Subsequently, 0.25 parts by mass of titanium tetrabutoxide serving as a catalyst is charged relative to 100 parts by mass of the monomer components. After stirring and reaction are carried out under nitrogen gas stream at 170° C. for 3 hours, the temperature is further elevated to 210° C. over a period of 1 hour, the inside of the reactor is depressurized to 3 kPa, and stirring and reaction are carried out at a reduced pressure for 13 hours to obtain a polyester resin. The glass transition temperature of the obtained resin measured by differential scanning calorimeter (DSC) is 58° C.

### Preparation of Polyester Resin Particle Dispersion

aforementioned polyester resin: 100 parts by mass
ethyl acetate: 70 parts by mass
isopropyl alcohol: 15 parts by mass

Into a jacketed stainless steel container, a mixed solvent of the ethyl acetate and the isopropyl alcohol is charged, and the polyester resin is gradually added to the mixed solvent and completely dissolved under stirring so as to obtain an oil phase. To the oil phase being stirred, a total of 3 parts by mass of a 10 mass % aqueous ammonia solution is gradually added dropwise via a pump, and 230 parts by mass of ion exchange water is gradually added at a rate of 10 L/min dropwise to perform phase inversion emulsification. Subsequently, reduced pressure distillation is performed to obtain a polyester resin particle dispersion (solid component concentration: 40 mass %). The solid component concentration is measured with a moisture meter MA35 (produced by Sartorius Mechatronics Japan K. K.). The solid component concentration of each of the samples below is also measured in the same manner.

The volume average particle diameter (D50v) of the polyester resin particles in the obtained polyester resin particle dispersion is 180 nm. The volume average particle diameter of the polyester resin particles is measured with a laser diffraction particle size distribution meter (LA-700: produced by Horiba Ltd.). The measurement method involves preparing a sample in a state of dispersion so that the solid content is about 2 g, adding ion exchange water to the sample to adjust the volume to about 40 mL, adding the sample to a cell until an appropriate concentration is reached, waiting 2 minutes to stabilize the concentration in the cell, and performing measurement. The volume average particle diameter for each of the obtained particle size ranges (channels) is accumulated from the smaller volume average particle diameter side, and the value at an accumulation of 50% is assumed to be the volume average particle diameter (D50v).

Preparation of Styrene Acrylic Resin Particle Dispersion
styrene: 77 parts
n-butyl acrylate: 23 parts
1,10-decanediol diacrylate: 0.4 parts
dodecanethiol: 0.7 parts

The aforementioned materials are mixed and dissolved, and a solution prepared by dissolving 1.0 part of an anionic surfactant (DOWFAX produced by Dow Chemical Company) in 60 parts of ion exchange water is added thereto. The resulting mixture is dispersed and emulsified in a flask to prepare an emulsion of monomers. Next, 2.0 parts of an anionic surfactant (DOWFAX produced by Dow Chemical Company) is dissolved in 90 parts of ion exchange water, 2.0 parts of the emulsion of monomers is added thereto, and 10 parts of ion exchange water in which 1.0 part of ammonium persulfate is dissolved is added to the resulting mixture. Next, the remainder of the emulsion of monomers is added thereto over a period of 3 hours, the inside of the flask is purged with nitrogen, the solution in the flask is heated on an oil bath until 75° C. while stirring, and the emulsification polymerization is continued under such conditions for 5 hours. As a result, a styrene acrylic resin particle dispersion is obtained. Ion exchange water is added to the styrene acrylic resin particle dispersion to adjust the solid content to 40%. The volume average particle diameter (D50v) of the particles in the styrene acrylic resin particle dispersion is 160 nm.

Preparation of Releasing Agent Particle Dispersion 1
paraffin wax (FNP92 produced by produced by Nippon Seiro Co., Ltd., endothermic peak onset: 81° C.): 45 parts
anionic surfactant (NEOGEN RK produced by DKS Co., Ltd.): 5 parts
ion exchange water: 200 parts

The aforementioned materials are mixed and heated to 95° C. The resulting mixture is dispersed by using a homogenizer (ULTRA-TURRAX T50 produced by IKA Japan). The resulting dispersion is then dispersed in a Manton-Gaulin high-pressure homogenizer (produced by Gaulin Company) to prepare a releasing agent particle dispersion (solid component concentration: 20%) containing a dispersed releasing agent. The volume average particle diameter of the releasing agent particles is 0.19 μm. In the table, paraffin wax is indicated as “paraffin”.

### Preparation of Releasing Agent Particle Dispersion 2

A releasing agent particle dispersion 2 is obtained as with the method for preparing the releasing agent particle dispersion 1 except that the paraffin wax is changed to carnauba wax (RC160 produced by TOA KASEI CO., LTD., endothermic peak onset: 85° C.). The volume average particle diameter of the obtained releasing agent particles is 0.21 μm. In the table, carnauba wax is indicated as “carnauba”.

### Preparation of Coloring Agent Particle Dispersion

cyan pigment (Pigment Blue 15:3 (copper phthalocyanine) produced by Dainichiseika Color & Chemicals Mfg. Co.): 98 parts
anionic surfactant (NEOGEN R produced by DKS Co., Ltd.): 2 parts ion exchange water: 400 parts

The aforementioned materials are mixed and dissolved, and the resulting mixture is dispersed for 10 minutes by using a homogenizer (IKA ULTRA-TURRAX) to obtain a coloring agent particle dispersion having a center particle diameter of 0.16 μm and a solid content of 20%.

### Preparation of Toner Particles

### Example 1

polyester resin particle dispersion: 400 parts
releasing agent particle dispersion 1:150 parts
coloring agent particle dispersion: 75 parts
anionic surfactant (DOWFAX 2A1 produced by Dow Chemical Company): 2 parts

The aforementioned components at a temperature of 20° C. are mixed, and ion exchange water is added thereto so that the solid component concentration (A) of the dispersion A is as indicated in Table. In a 3 L reactor equipped with a thermometer, a pH meter, and a stirrer at a temperature of 25° C., the mixture is mixed and dispersed by using the stirrer and a homogenizer (ULTRA-TURRAX T50 produced by IKA Japan) while 100 parts of an aqueous aluminum sulfate solution having a concentration of 1.0% serving as an aggregating agent is added, and stirring is continued for 10 minutes while adjusting the speed of rotation according to the liquid viscosity of the dispersion. Next, the homogenizer is removed from the reactor, the pH of the system is adjusted to 3.0 by adding 1.0% nitric acid, a heating mantle is installed to the reactor, and heating is performed while adjusting the speed of rotation of the stirring according to the liquid viscosity of the dispersion. Then a temperature of 45° C. is retained for 60 minutes to prepare a dispersion A that contains first aggregated particles obtained by aggregation of the resin particles, the releasing agent particles, and the coloring agent particles (first aggregation step).

To the dispersion A, 200 parts of the polyester resin particle dispersion having a solid component concentration (B) adjusted with ion exchange water so that the concentration is as indicated in Table is added as the dispersion B that contains shell resin particles at an addition rate and an amount indicated in Table at 45° C. After all of the dispersion B is added, the resulting mixture is retained at 45° C. for 30 minutes, and then 8 parts of a 20% EDTA (ethylenediamine tetraacetate) solution is added to the reactor. Thereto, a 1 mol/L aqueous sodium hydroxide solution is added to control the pH in the system from 3.0 to 9.0 so that the shell resin particles adhere to the first aggregated particles and thereby second aggregated particles are formed (second aggregation step).

Subsequently, heating is performed at a heating rate of 1° C./minute to 90° C., and then the temperature is retained for 2 hours to heat and fuse the second aggregated particles to form toner particles (fusing step).

After completion of heating and retaining, the reactor is cooled with cooling water to 30° C. over a period of 5 minutes, and the cooled slurry is passed through a nylon mesh having 15 μm openings to remove coarse particles. Then ion exchange water is passed through the filtrate until the electrical conductivity reaches 10 μS/cm or less while performing solid-liquid separation by Nutsche suction filtration to wash the filtrate (solid-liquid separation step and washing step). The washed solid cake is finely pulverized with a wet-dry-type particle sizer (Comil), and vacuum freeze drying is continued for 24 hours to obtain toner particles 1 (drying step).

### Preparation of Toner 1

To 100 parts by mass of the obtained toner particles 1, the external additive described in Table in an amount described in Table and 1.5 parts by mass of hydrophobic silica (RY 50 produced by Nippon Aerosil Co., Ltd., number-average particle diameter: 40 nm) are mixed and blended by using a sample mill at 10,000 rpm for 30 seconds.

Subsequently, the resulting product is sieved through a vibrating sieve having 45 μm openings to prepare a toner 1 (toner for developing an electrostatic charge image). The volume average particle diameter of the obtained toner 1 is 5.5 μm.

### EXAMPLES 2 to 21 and COMPARATIVE EXAMPLES 1 and 2

Toners are produced as in Example 1 except that the solid component concentration (A) of the dispersion A, the solid component concentration (B) of the dispersion B, the difference (B)−(A) between the solid component concentration (A) and the solid component concentration (B), the volume average particle diameter of the first aggregated particles, the volume average particle diameter of the shell resin particles, the ratio of the volume average particle diameter of the first aggregated particles to the volume average particle diameter of the shell resin particles (first aggregated particles/shell resin particles), the addition rate of the dispersion B, the type of the releasing agent, and the type and amount of the external additive are changed as indicated in Table.

The external additive used in Example 21 is as follows.
hydrophobic silica (RY200 produced by Nippon Aerosil Co., Ltd., number-average particle diameter: 110 nm)

### Example 3B

A toner is produced as in Example 1 except that, in preparing the dispersion A, a styrene acrylic resin particle dispersion is used instead of the polyester resin particle dispersion.

### Measuring Releasing Agent Surface Exposure Ratio in Toner Particles

The releasing agent surface exposure ratio is measured by X-ray photoelectron spectroscopy (XPS). XPS measurement is performed on the toner particles as the measurement sample. The XPS meter used is JPS-9000MX produced by JEOL Ltd., MgKa radiation is used as the X-ray source, the accelerating voltage is set to 10 kV, and the emission current is set to 30 mA. Here, the amount of the releasing agent on the surfaces of the toner particles is determined by a Cls spectrum peak resolving method. The peak resolving method involves splitting the measured Cls spectrum by curve fitting through a least squares method. Of the split peaks, the peak area derived from the releasing agent and the composition ratio are used to calculate the exposure ratio (area %). The component spectra used as the base for resolving are C1s spectra obtained by independently measuring the releasing agent and the resins used in preparation of the toner particles.

Since the toner is externally added with the external additive, the toner is dispersed in a mixture of ion exchange water and a dispersing agent such as a surfactant, and the resulting mixture is ultrasonically treated by using an ultrasonic homogenizer (US-300T produced by NIHONSEIKI KAISHA LTD.) or the like to ultrasonically separate the external additive and the toner particles. Subsequently, after filtration and washing, the particles are dried and recovered to obtain only the toner particles from which the external additive is separated, and these toner particles are used as the measurement sample.

### Thermal Storage Property Evaluation

In a 55° C., 50% RH environment, 2 g of the obtained toner for developing an electrostatic charge image is stored for 10 hours, and the state after the storage is visually observed and evaluated according to the following evaluation standard. The evaluation results of A and B are acceptable

A: Aggregates are rarely observed. Excellent thermal storage property.

B: A small quantity of aggregates are observed, and the thermal storage property is slightly inferior to A.

C: Aggregates are observed, and the thermal storage property is inferior to B but is within the acceptable range.

D: The toner has undergone aggregation and has no thermal storage property.

### Image Density Stability Evaluation

The carrier prepared as described below and toners for developing electrostatic charge images of respective examples are used to prepare electrostatic charge image developers.

### Preparation of Carrier

After 500 parts of spherical magnetite powder particles (volume average particle diameter: 0.55 μm) are thoroughly stirred in a HENSCHEL mixer, 5.0 parts of a titanate coupling agent is added, and the resulting mixture is heated to 100° C. and then stirred for 30 minutes. As a result, titanate coupling agent-coated spherical magnetite particles are obtained. Next, into a four-necked flask, 6.25 parts of phenol, 9.25 parts of 35% formalin, 500 parts of the aforementioned magnetite particles, 6.25 parts of 25% ammonia water, and 425 parts of water are placed, and the resulting mixture is mixed and stirred. Next, the reaction is carried out under stirring at 85° C. for 120 minutes, the resulting mixture is cooled to 25° C., 500 parts of water is added thereto, the supernatant is removed, and the deposits are washed with water. The washed deposits are dried at 150° C. or higher and 180° C. or lower to obtain a carrier having a volume average particle diameter of 35 μm.

### Preparation of Electrostatic Charge Image Developer 1

The obtained carrier and each of the toners of the examples are placed in a V blender at a toner-to-carrier ratio of 5:95 (mass ratio), and the resulting mixture is stirred for 20 minutes. As a result, an electrostatic charge image developer is obtained.

A modified model obtained by placing the obtained electrostatic charge image developer of each example into a developing device of DocuCenter Color 400 (produced by FUJIFILM Business Innovation Corp.) is left to stand in a low-temperature, low-humidity environment having a temperature of 10° C. and a relative humidity of 15% for 24 hours. A test chart having an area coverage of 5% is continuously output on 50,000 sheet of A4 regular paper in an environment having a temperature of 10° C. and a relative humidity of 15%. A spectrophotometer (X-Rite Ci62 produced by X-Rite Inc.) is used to measure the L* value, the a* value, and the b* value at three positions in each of images on the 1,000 sheet and the 50,000th sheet, and the color difference ΔE is calculated and evaluated according to the following standard. The evaluation results of A and B are acceptable

A: In the images on the 1,000th sheet and the 50,000th sheet, the color difference ΔE is 1 or less, and the difference in density is small.

B: In the images on the 1,000th sheet and the 50,000th sheet, the color difference ΔE is more than 1 and 3 or less. The difference in density is small.

C: In the images on the 1,000th sheet and the 50,000th sheet, the color difference ΔE is more than 3 and 5 or less. There is a difference in density but the level thereof is acceptable.

D: In the images on the 1,000th sheet and the 50,000th sheet, the color difference ΔE is more than 5. There is a difference in density and the level thereof is unacceptable.

ΔE=\sqrt{(L₁−L₂)²+(a₁−a₂)²+(b₁−b₂)²}

The results of the respective examples are indicated in Table.

TABLE

| | | | | | | | | | Ratio of | | | | | | |
|---|---|---|---|---|---|---|---|---|---|---|---|---|---|---|---|
| | | | | | | | | | average particle | | | | | | |
| | | | | | | | Average | | diameter of | | | | | | |
| | | | | | Average | Average | particle | | shell resin | | | | | | |
| | Solid | | | Solid | particle | particle | diameter | Addition | particles | | | | Releasing | | |
| | component | | | component | diameter | diameter | ratio of first | rate of | to solid | | | | agent | | |
| | concentration | | | concentration | of first | of shell | aggregated | dispersion | component | | | Amount of | surface | | |
| | (A) of | Relationship | | (B) of | aggregated | resin | particles to | B (parts by | concentration | Type of | Type of | external | exposure | Thermal | Image |
| | dispersion A | between | | dispersion B | particles | particles | shell resin | mass per | (B) of | releasing | external | additive | ratio | storage | density |
| | (mass %) | (A) and (B) | (B)-(A) | (mass %) | (nm) | (nm) | particles | minute) | dispersion B | agent | additive | (parts) | (area %) | property | stability |
| Example 1 | 18.5 | < | 5.5 | 24.0 | 4800 | 180 | 27 | 0.8 | 7.5 | Paraffin | RY50 | 1.5 | 4 | B | C |
| Example 2 | 16.0 | < | 9.0 | 25.0 | 4800 | 180 | 27 | 0.8 | 7.2 | Paraffin | RY50 | 1.5 | 4 | B | C |
| Example 3 | 14.0 | < | 11.0 | 25.0 | 4800 | 180 | 27 | 0.8 | 7.2 | Paraffin | RY50 | 1.5 | 2 | A | A |
| Example 3B | 14.0 | < | 11.0 | 25.0 | 4800 | 160 | 30 | 0.8 | 6.4 | Paraffin | RY50 | 1.5 | 3 | B | B |
| Example 4 | 12.0 | < | 20.0 | 32.0 | 4800 | 180 | 27 | 0.8 | 5.6 | Paraffin | RY50 | 1.5 | 3 | B | C |
| Example 5 | 5.5 | < | 29.5 | 35.0 | 4800 | 180 | 27 | 0.8 | 5.1 | Paraffin | RY50 | 1.5 | 5 | C | C |
| Example 6 | 14.0 | < | 11.0 | 25.0 | 4800 | 180 | 27 | 0.65 | 7.2 | Paraffin | RY50 | 1.5 | 8 | C | C |
| Example 7 | 14.0 | < | 11.0 | 25.0 | 4800 | 180 | 27 | 1.1 | 7.2 | Paraffin | RY50 | 1.5 | 7 | C | C |
| Example 8 | 14.0 | < | 2.0 | 16.0 | 4800 | 180 | 27 | 0.8 | 11.3 | Paraffin | RY50 | 1.5 | 7 | C | C |
| Example 9 | 7.0 | < | 33.0 | 40.0 | 4800 | 180 | 27 | 0.8 | 4.5 | Paraffin | RY50 | 1.5 | 10 | C | C |
| Comparative | 14.0 | > | −4.0 | 10.0 | 4800 | 180 | 27 | 0.8 | 18.0 | Paraffin | RY50 | 1.5 | 15 | D | D |
| Example 1 | | | | | | | | | | | | | | | |
| Comparative | 16.0 | = | 0.0 | 16.0 | 4800 | 180 | 27 | 0.8 | 11.3 | Paraffin | RY50 | 1.5 | 14 | D | D |
| Example 2 | | | | | | | | | | | | | | | |
| Example 10 | 22.0 | < | 6.0 | 28.0 | 4800 | 180 | 27 | 0.8 | 6.4 | Paraffin | RY50 | 1.5 | 7 | C | C |
| Example 11 | 4.5 | < | 10.5 | 15.0 | 4800 | 180 | 27 | 0.8 | 12.0 | Paraffin | RY50 | 1.5 | 9 | C | C |
| Example 12 | 12.0 | < | 13.0 | 25.0 | 4800 | 180 | 27 | Added all | 7.2 | Paraffin | RY50 | 1.5 | 8 | C | C |
| | | | | | | | | at once | | | | | | | |
| Example 13 | 14.0 | < | 11.0 | 25.0 | 4800 | 180 | 27 | 1.4 | 7.2 | Paraffin | RY50 | 1.5 | 10 | C | C |
| Example 14 | 14.0 | < | 11.0 | 25.0 | 2800 | 180 | 16 | 0.8 | 7.2 | Paraffin | RY50 | 1.5 | 10 | C | C |
| Example 15 | 14.0 | < | 11.0 | 25.0 | 7500 | 180 | 42 | 0.8 | 7.2 | Paraffin | RY50 | 1.5 | 9 | C | C |
| Example 16 | 14.0 | < | 11.0 | 25.0 | 3100 | 360 | 9 | 0.8 | 14.4 | Paraffin | RY50 | 1.5 | 10 | C | C |
| Example 17 | 14.0 | < | 11.0 | 25.0 | 6900 | 70 | 99 | 0.8 | 2.8 | Paraffin | RY50 | 1.5 | 7 | C | C |
| Example 18 | 19.0 | < | 20.0 | 39.0 | 4800 | 76 | 63 | 0.8 | 1.9 | Paraffin | RY50 | 1.5 | 7 | C | C |
| Example 19 | 6.0 | < | 10.0 | 16.0 | 4800 | 340 | 14 | 0.8 | 21.3 | Paraffin | RY50 | 1.5 | 8 | C | C |
| Example 20 | 14.0 | < | 11.0 | 25.0 | 4800 | 180 | 27 | 0.8 | 7.2 | Carnauba | RY50 | 1.5 | 10 | C | C |
| Example 21 | 16.0 | < | 9.0 | 25.0 | 4800 | 180 | 27 | 0.8 | 7.2 | Paraffin | RY200 | 1.5 | 7 | C | C |

Table indicates that, compared to the methods for producing a toner for developing an electrostatic charge image of the comparative examples, the methods for producing a toner for developing an electrostatic charge image of the examples offer a small releasing agent surface exposure ratio in the obtained toner particles. Furthermore, as indicated in Table, compared to the methods for producing a toner for developing an electrostatic charge image of the comparative examples, the methods for producing a toner for developing an electrostatic charge image of the examples offer excellent thermal storage property of the obtained toner for developing an electrostatic charge image, and excellent image density stability.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A method for producing a toner for developing an electrostatic charge image, the method comprising:
performing first aggregation involving aggregating at least resin particles and releasing agent particles to prepare a dispersion A that contains first aggregated particles that will form a core;
performing second aggregation involving adding, to the dispersion A, a dispersion B that contains shell resin particles that will form a shell so as to cause the shell resin particles to adhere to the first aggregated particles and form second aggregated particles; and
performing fusion involving heating and fusing the second aggregated particles to form toner particles,
wherein a solid component concentration (A) of the dispersion A and a solid component concentration (B) of the dispersion B satisfy a relationship, (A)<(B).

2. The method for producing a toner for developing an electrostatic charge image according to claim 1, wherein a difference ((B)−(A)) between the solid component concentration (B) of the dispersion B and the solid component concentration (A) of the dispersion A is 5 mass % or more and 30 mass % or less.

3. The method for producing a toner for developing an electrostatic charge image according to claim 2, wherein the difference ((B)−(A)) between the solid component concentration (B) of the dispersion B and the solid component concentration (A) of the dispersion A is 8 mass % or more and 15 mass % or less.

4. The method for producing a toner for developing an electrostatic charge image according to claim 1, wherein the solid component concentration (A) of the dispersion A is 5 mass % or more and 20 mass % or less.

5. The method for producing a toner for developing an electrostatic charge image according to claim 1, wherein the solid component concentration (B) of the dispersion B is 15 mass % or more and 40 mass % or less.

6. The method for producing a toner for developing an electrostatic charge image according to claim 1, wherein the first aggregated particles have a volume average particle diameter of 3000 nm or more and 7200 nm or less.

7. The method for producing a toner for developing an electrostatic charge image according to claim 6, wherein a ratio of the volume average particle diameter of the first aggregated particles to a volume average particle diameter of the shell resin particles is 10 or more and 90 or less.

8. The method for producing a toner for developing an electrostatic charge image according to claim 1, wherein, in the second aggregation, an addition rate of the dispersion B relative to 100 parts by mass of the dispersion A is 0.1 parts by mass per minute or more and 1.2 parts by mass per minute or less.

9. The method for producing a toner for developing an electrostatic charge image according to claim 1, wherein a volume average particle diameter (nm) of the shell resin particles to the solid component concentration (B) of the dispersion B is 2 or more and 20 or less.

10. A toner for developing an electrostatic charge image, the toner being obtained by the method for producing a toner for developing an electrostatic charge image according to claim 1.
